(19) United States
(12) Patent Application Publication
(10) Pub. No.: US 2002/0186921 A1
(43) Pub. Date: Dec. 12, 2002

(54) Multiwavelength optical fiber devices

(76) Inventors: Lynn C. Schumacher, Toronto (CA); Ben G. Yacobi, Mississauga (CA)

Correspondence Address: DOWELL & DOWELL PC, SUITE 309, 1215 JEFFERSON DAVIS HIGHWAY, ARLINGTON, VA, 22202

(21) Appl. No.: 09/874,225

(22) Filed: Jun. 6, 2001

(51) Int. Cl. G02B 6/26; G02B 6/22

(52) U.S. Cl. 385/31; 385/128

(57) ABSTRACT

The present invention provides optical fiber devices, which emit optical radiation at pre-selected multiple wavelengths. The fiber devices incorporate semiconductor nanocrystals into the fiber core or cladding which fluoresce when irradiated by light of greater energy than the energy gap of the nanocrystal. The nanocrystals are chosen so that, when irradiated by an excitation source, they fluoresce thereby emiting optical radiation and, thus, act as a light source with tunable wavelength of emission depending on the size of nanocrystal, which is incorporated within the fiber itself. In one embodiment the fiber optic device is a fiber optic diffuser, which emits at multiple wavelengths by incorporating semiconductor nanocrystals having a preselected distribution of sizes, and such multi-wavelength diffusers offer an additional capability of tuning the spectral content of diffused radiation for specific medical or fiber optic communication applications.

### FIELD OF THE INVENTION

The present invention relates to optical fiber devices for producing and emitting optical radiation at pre-selected multiple wavelengths (i.e., multiwavelengths), and more particularly the invention relates to optical fiber diffusers and methods of producing them with pre-selected light intensity and wavelength distributions along the length of the diffuser.

### BACKGROUND OF THE INVENTION

The use of optical fiber as a waveguide to deliver light from a light source to a remote location has long been considered desirable and currently has became practical in a myriad of applications.

Lasers and optical fibers have been also used in various medical applications, and in many cases, lasers have been combined with optical fiber devices for delivery of focused radiation to interior parts of the body for surgical or illumination purposes. In some instances, fiber optic catheters, containing a combination of various fiber optic bundles with different functionalities, such as viewing, illumination, laser removal of tissue or delivering therapeutic laser radiation, have been employed.

A number of medical applications, such as photodynamic therapy, interstitial laser photocoagulation or interstitial laser hyperthermia for tumor destruction, require a diffuser that emits laser light radially from the optical fiber. One of the main challenges of making such a device is to have the light emitted homogeneously along the length of the diffuser tip. In some applications the fiber diffuser needs to be thin enough to allow them to be inserted through various medical devices such as endoscopes, hollow-bore needles, catheters and the like.

Present cylindrical fiber diffusers use micro-beads or Rayleigh scatterers distributed along the fiber tip to scatter the light radially. The amount of light scattered can be controlled by the size and density of microbeads. The diffuser outer diameters range from 0.356 to 1.4 mm (typically 1 mm). U.S. Pat. Nos. 5,196,005 and 5,330,465 issued to Doiron et al. disclose such a diffuser tip having scattering centers embedded in a silicone extension that abuts the end of an optical fiber. The scattering centers are embedded in the silicone in such a way that they increase in density from the proximal end of the diffuser abutting the optical fiber to the distal end of the diffuser. U.S. Pat. No. 5,269,777 issued to Doiron et al. discloses a diffuser tip having a silicone core attachable to the end of an optical fiber. The cylindrical silicone extension is coated with an outer silicone layer having scattering centers embedded therein.

U.S. Pat. No. 5,643,253 issued to Baxter et al. is related to an optical fiber diffuser including an attachment that abuts the end of an optical fiber. The diffuser includes a cylindrical polymeric section in which scattering centers are embedded.

U.S. Pat. No. 4,986,628 issued to Lozbenko et al. describes an optical fiber diffuser attachment that abuts the end of an optical fiber. The diffuser is made of an optically turbid medium, which may be polymer based which is contained in a protective envelope or sheath that slides over the end of the optical fiber.

U.S. Pat. No. 5,207,669 issued to Baker et al. discloses an optical fiber diffuser tip that abuts the end of an optical fiber for providing uniform illumination along the length of the diffuser tip. The diffuser section is produced by thinning the higher refractive index cladding surrounding the multimode fiber core, so it has a thickness less than the penetration depth of the evanescent field to permit penetration of the cladding by the evanescent fields along the diffuser section. Some of the light propagating down the fiber core will therefore be emitted and some reflected back into the core at each point along the diffuser tip.

There are several inherent disadvantages of these types of diffusers including difficulty in achieving illumination homogeneity for long diffusers, and that typically they emit preferentially in the direction of propagation of light in the fiber (i.e., they are non-Lambertian emitters), and that many are restricted to use at the ends of the optical fiber, and the diffuser tips can break loose at high light intensity as have been observed and they are relatively expensive in that separate diffuser tips have to be produced and attached to the end of the optical fiber.

Another shortcoming of present optical fiber diffusers is that they rely upon micron size scattering centers, which act to scatter the radiation and thus the scattered radiation is always of the same wavelength as the light incident on the scattering section of the fiber.

Therefore, there is a need for optical diffusers, which emit radiation at preselected multiple wavelengths, and which can be either affixed to the end of a fiber or built directly into the optical fiber itself. Such multi-wavelength diffusers may also offer an additional capability of tuning the spectral content of diffused radiation for specific medical or fiber optic communication applications.

### SUMMARY OF THE INVENTION

It is an object of the present invention to provide an optical fiber diffuser device that can be produced in any portion of an optical fiber. It is also an objective of the present invention to provide an optical fiber diffuser device that is integrally formed with an optical fiber.

An advantage of the optical fiber diffuser devices constructed in accordance with the present invention is that they can be produced with variable intensity distributions along the length of the diffuser as required for the particular application for which the diffuser is designed. Another advantage of the diffusers is that they are not attached to the end of the fiber as a separate piece but are formed anywhere along the optical fiber as part of the fiber itself.

In medical applications, it is also highly desirable to control (or diffuse, or attenuate) laser radiation for various purposes, e.g., illumination, avoidance of damage with high laser power beams, etc. Thus, instead of using additional components for this purpose, this invention offers such a capability that is built-in directly into the fiber.

In accordance with the present invention, a passive optical beam diffuser is realized in a section of an optical fiber or a waveguide having a core and cladding, which may be formed, for example, from a fused silica fiber that incorporates the nanocrystals. By varying the type, the size, and the concentration of nanocrystals, the selected degree of diffusion/attenuation can be realized as a function of wavelength. In other words, selected wavelengths of radiation may be diffused/attenuated to a larger extent than others, say in the range between about 300 and 1550 nm. Also, by placing nanocrystals in a controlled manner in predetermined sections of the optical fiber, say distance L between two such sections that define an optical signal path-length, a calibration means of light propagations can be realized based on the excitation and analysis of light originating from the said nanocrystals placed in predetermined manner with known distances between them. This provides a controlled degree of optical diffusion/attenuation between two sections of optical fiber.

In one aspect of the invention there is provided an optical fiber device with a multiwavelength output, comprising:

a multimode optical fiber having a fiber core, a cladding and a buffer enveloping said cladding, semiconductor nanoparticles of pre-selected size embedded in one or both of said core and cladding along a pre-selected length thereof, said semiconductor nanoparticles emitting electromagnetic radiation of pre-selected wavelengths by fluorescence responsive to being irradiated by electromagnetic radiation.

In another aspect of the invention there is provided an optical fiber diffuser, comprising:

a multimode optical fiber having a fiber core, a cladding and a buffer enveloping said cladding, semiconductor nanoparticles of pre-selected size embedded in said core along a pre-selected length thereof, said buffer being removed along said pre-selected length, said nanoparticles emitting electromagnetic radiation of pre-selected wavelength responsive to being irradiated by electromagnetic radiation propagating along said fiber core from a light source optically coupled to said optical fiber.

The semiconductor nanocrystals may have a mean size selected so that the fluorescence has a wavelength in a pre-selected wavelength range.

In another aspect of the present invention there is provided a diffuser tip, comprising a proximal end which abuts against the tip of an optical fiber or array of fibers and a distal end, said diffuser tip comprising a cylindrical central core of a substantially transparent elastomer, said core containing semiconductor nanoparticles of pre-selected size embedded therein.

The semiconductor nanoparticles may be distributed within the cylindrical central core so that the concentration of semiconductor nanoparticles increase continuously in a direction from the proximal end of the diffuser tip to the distal end of the diffuser tip. The semiconductor nanocrystals may have a mean size selected so that the fluorescence has a wavelength in a pre-selected wavelength range.

### BRIEF DESCRIPTION OF THE DRAWINGS

The invention will now be described, by way of non-limiting examples only, reference being had to the accompanying drawings, in which:

FIG. 1 shows a longitudinal cross section of a multimode fiber diffuser constructed in accordance with the present invention using nanoparticles;

FIG. 2a shows a longitudinal cross section of another multimode fiber diffuser using nanoparticles located at the distal end or tip of the fiber and in its core;

FIG. 2b shows a longitudinal cross section of another multimode fiber diffuser using nanoparticles at a selected location of the fiber and in its core;

FIG. 2c shows a longitudinal cross section of another multimode fiber diffuser using nanoparticles at a selected location of the fiber and in its cladding;

FIG. 3 shows a longitudinal cross section of a second alternative embodiment of a fiber diffuser;

FIG. 4 shows a longitudinal cross section of a third alternative embodiment of a fiber diffuser;

FIG. 5 shows a longitudinal cross section of a light detector using a fiber optic incorporating nanoparticles; and

FIG. 6 shows a longitudinal cross section of a fiber optic incorporating nanoparticles and containing a grating.

### DETAILED DESCRIPTION OF THE INVENTION

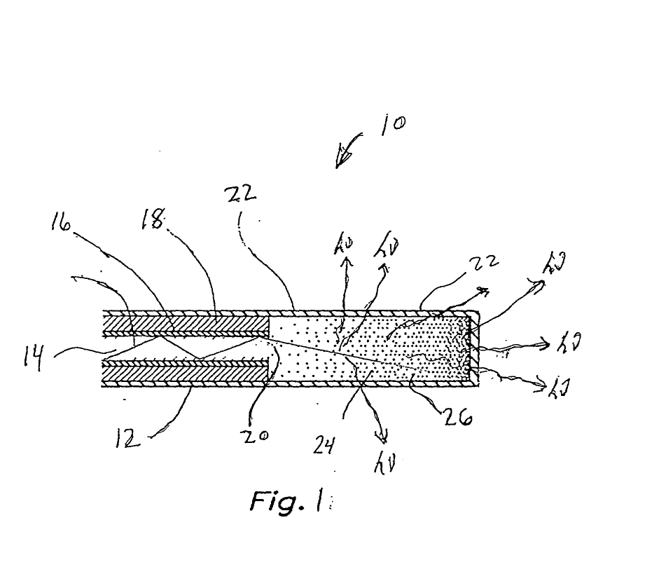

The present invention provides optical fiber diffusers for light propagating through an optical fiber. A first embodiment of a fiber diffuser is shown generally at 10 in FIG. 1. Diffuser 10 includes a fiber optic 12 having a fiber core 14, a cladding 16 and may include a protective jacket (buffer) 18 with the fiber optic having a planar end portion 20. A cylindrical diffuser tip 22 abuts up against planar end portion 20 and includes a diffuser core material 24 containing nanocrystals 26 dispersed therethrough.

The diffuser 10 is produced by incorporating into the core material 24 (which for example is transparent silicone) nanocrystals 26. Nanocrystals 26 are chosen so that, when irradiated by an excitation source, they fluoresce thereby emiting radiation and thus act as a light source, with tunable wavelength of emission depending on the nanocrystal size, which is incorporated within the material itself.

As used herein, the term “nanocrystals” refers to nanoparticles, which can emit radiation responsive to some form of excitation energy. Therefore it will be understood that the term “nanocrystals” as used herein is not restricted to crystalline structures, although crystalline nanoparticles such as crystalline semiconducting nanocrystals are a preferred embodiment. However, noncrystalline semiconductor nanoparticles and other inorganic or organic nanoparticles may also be used and fall within the meaning of nanocrystals as used herein.

Semiconductor nanocrystals, which have generated great interest in recent years and which constitute a preferred mode of the present invention, are described in the references listed hereinafter in the section entitled References Cited. These nanocrystals are capable of emitting optical radiation within a narrow wavelength depending on the size of the nanocrystals. These nanocrystals are also referred to as quantum dots.

In general, nanocrystals have dimensions between about 1 nm and 50 nm (typically, the nanocrystals have an average cross-section ranging in size from about 1 nm to about 10 nm), and their structural properties, such as lattice structure and bond spacing, are similar to a macroscopic counterpart of the material. Nanocrystals exhibit quantum size effects, which arise when their size is commensurate with de Broglie wavelength of an elementary particle (e.g., electron, or hole, or an exciton). Due to the quantum size effect, semiconductor nanocrystals exhibit discrete optical transitions as the result of the confinement of the electron-hole pairs, and their optical properties are strongly dependent on the size of the nanocrystal, with the onset of absorbance and maximum of fluorescence spectrum being shifted to higher energy with decreasing size. The types of nanocrystals can be listed as follows: group I-VII materials such as CuCl, AgBr, or NaCl; group II-VI materials such as HgS, HgSe, HgTe, CdSe, CdS, CdTe, ZnSe, ZnTe, ZnO, ZnS, or alloys of these materials; group IV-VI materials such as PbS, PbSe, PbTe, or alloys of these materials, group III-V materials such as GaP, GaAs, InP, InAs, InSb, or alloys of these materials; group IV materials such as C, Si, Ge, or alloys of these materials; metals such as Ni, Cu, Ag, Pt, or Au; or metal oxides such as silica, titania, alumina, or zirconia.

The synthesis and various applications of the said nanocrystals are described in several papers and U.S. Patents. For example, the synthesis of nanocrystalline II-VI and II-V compounds is described by Alivisatos et al. in U.S. Pat. Nos. 5,262,357, 5,505,928, and 5,751,018; specifically, U.S. Pat. No. 5,751,018 describes methods for attaching nanocrystals to solid inorganic surfaces by employing “self-assembled bifunctional organic monolayers as bridge compounds”. Another example of the preparation of various III-V semiconductors was described by Nozik et al. (MRS Bulletin vol. 23, pp. 24-30, February 1998) for InAs, InP, GaAs, and GaP, which can be formed into powders or suspended in solids such as polymers and glasses.

One preferable type of nanocrystal that may be used are those having the so-called core/shell configuration, i.e. a system with one semiconductor nanocrystal forming a core (with the size between about 1 nm and 10 nm) and with another semiconductor forming a shell (of one to several monolayers thick) over the core nanocrystal. This results in passivating the surface of the core nanocrystal leading to a substantial enhancement in the emission of optical radiation. As an example, formation of CdS layer over a CdSe core results in a significant enhancement of the luminescence quantum yield (see, for example, Alivisatos, A. P., MRS Bulletin, vol. 23, pp. 18-23, February 1998). Substantial research programs and applications relating to the use of nanocrystals in various structures and devices are currently in progress. The semiconductor nanocrystals embedded in a polymer matrix may have utility in areas, such as optical modulators and switches for use in telecommunications systems, described in U.S. Pat. No. 6,005,707. Luminescent semiconductor nanocrystals can be also employed as probes for biological applications, as described in U.S. Pat. No. 5,990,479. The utility of doped nanocrystals, such as ZnS doped with a manganese luminescent center, was described by Bhargava et al. (Journal of Luminescence, Vols. 60 and 62, pp. 275-280, 1994). Research and various applications of the nanocrystals are also discussed, for example, in MRS Bulletin (Volume 23, No. 2, February 1998).

It is noted that, although the luminescent semiconductor nanocrystals can be excited over a wide wavelength range, they emit optical radiation in a relatively narrow wavelength band. In principle, the nanocrystals can be excited by the optical radiation (i.e., UV, visible, and infrared), as well as by x-rays or by the irradiation with an electron beam. The important feature of the excitation of the nanocrystals having different sizes is that one source can lead to the concurrent excitation of all of the nanocrystals, and thus result in the narrow-band emission of the optical radiation at different wavelengths, which are tunable by selecting the appropriate size distribution of the nanocrystals.

The size of nanocrystals (or the size distribution of nanocrystals) incorporated in the diffuser core material is selected based on the radiation content required for the particular application for which the diffuser is being utilized. In medical applications, this feature can provide advantages related to the facts that (i) the diffuser is built-in directly into the fiber (i.e. no additional lenses, or other accessories have to be incorporated) and (ii) the diffuser also provides an additional radiation with pre-selected spectral content. Thus, the material may be illuminated with any appropriate optical radiation, but nanocrystals, in turn, will fluoresce according to their size-dependent separation in energy levels. The shapes of the nanocrystals will have a smaller effect on the wavelength dependence of the fluorescence and thus the nanoparticles may have any shape and are not restricted to being spherical.

When the diffuser tip 22 is illuminated with optical irradiation with a photon energy exceeding the magnitudes of the energy gap of all (or in some cases, some) of the nanocrystals having different sizes, incorporated in core material 24, each of these nanocrystals will fluoresce at a characteristic wavelength corresponding to the specific size of the nanocrystal, thus providing optical radiation with a multi-wavelength output. The emission can be tuned by selecting the mean size (mean diameter in the case of spherical particles), or size distribution, of the nanocrystals. Thus, the spectral content of the fluorescence, originating within the material, can be also tuned or selected a priori, by incorporating a given size distribution of nanocrystals. Therefore for a wavelength output at a single wavelength the nanoparticles would be essentially of the same size (monodisperse).

Another parameter over which control can be exercised is the distribution of the nanoparticles throughout the diffuser core 24. FIG. 1 shows a gradient of the nanoparticles increasing from the proximal end of core material 24 adjacent to planar face 20 to the distal end 28 of diffuser core 24. The particular type of non-uniform distribution gradient of nanoparticles throughout along diffuser core 24 may be tailored to match the absorption coefficient of the material from which diffuser core 24 is produced (for example silicone) in order to ensure substantially uniform illumination emitted from core 24 along its length. U.S. Pat. No. 5,196,005, which is incorporated herein in its entirety, discloses a method of production of diffusion tips for optical fibers using extrusion. A dual injector system injects an elastomeric material in one injector with scatterers in another injector. The scatterers and elastomeric material are mixed in a ratio which is changed to give a gradient in the scatterers throughout the elastomer. This system can be used where nanoparticles are substituted for the scafterers.

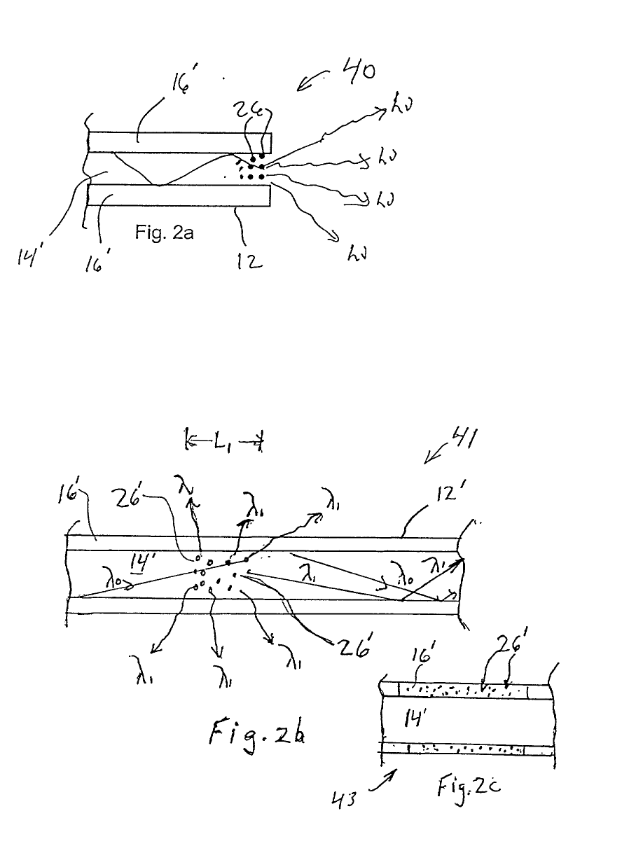

Another embodiment of another fiber optic diffuser is shown generally at 40 in FIG. 2a. In diffuser device 40 the nanoparticles 26 are integrated directly into the core 14′ of fiber 12′ and are located at the distal end or tip of the fiber optic diffuser out of which the light is emitted. The volume percent of the nanoparticles added into the fiber core during production thereof is in a range from greater than zero to an upper value which does not deleteriously affect the structural integrity of the fiber core or the functionality of the core in respect of acting as a waveguide. The optical fibers may be glass optical fibers or polymer-based optical fibers.

Another embodiment of a fiber optic diffuser is shown generally at 41 in FIG. 2b. In diffuser device 41 the nanoparticles 26 are integrated directly into the core 14′ of fiber 12′ and extend along a length L₁ of the fiber. The volume percent of the nanoparticles added into the fiber core (in all embodiments disclosed herein) during production thereof is in a range from greater than zero to an upper value which does not deleteriously affect the structural integrity of the fiber core or the functionality of the core in respect of acting as a waveguide. The fibers may be glass fibers or polymer-based optical fibers.

Yet another embodiment of a fiber optic diffuser is shown generally at 43 in FIG. 2c. In diffuser device 43 the nanoparticles 26 are integrated directly into the cladding 16′ of fiber 12′ and extend along a length L₁ of the fiber. To prepare this type of diffuser the buffer is removed along the selected length and the cladding thinned or removed. The nanoparticles are mixed with a polymer having a suitable refractive index and the thinned portion of the cladding is re-coated. It is noted that in this configuration the fiber may be re-coated with a buffer so that it does not act as a diffuser but may simply be used to inject optical radiation having multiple wavelengths into the fiber core. In this embodiment, the nanoparticles may act as reference points for testing or any other measurement purposes related to the geometry, configuration or arrangement of the optical fibers. The volume percent of the nanoparticles added into the fiber cladding during production thereof is in a range from greater than zero to an upper value which does not deleteriously affect the structural integrity of the fiber cladding.

Thus, the primary beam in the optical fiber is attenuated/diffused by means of absorption of the primary source radiation by the nanocrystals having different sizes (or size distributions) and subsequent isotropic emission of diffused radiation at different selectable wavelengths as compared to the primary radiation beam. Some of the isotropically emitted light will exit the fiber in the radial direction.

The sizes of nanocrystals that are incorporated in the material 24 are preferably between 1 and 100 nm, and more preferably between 1 and 50 nm, and in most preferable cases, for achieving quantum size effects, between 1 and 10 nm. Nanocrystal sizes in the range between 1 and 10 nm are especially useful for obtaining a wide range of maxima of fluorescence spectra depending on nanocrystal size.

In view of the above-described properties of nanoparticles, various embodiments of the present fiber optic diffuser may be constructed. Referring again to FIG. 2b, in the case where the particles are monodisperse the diffuser emits at one wavelength λ₁. Some of the light emitted by the nanoparticles 26′ at wavelength λ₁ will be confined to the fiber core 14′ and will propagate along the core so that two wavelengths λ₀ and λ₁ propagate down the core.

Thus, incorporating for example semiconductor nanocrystals of pre-selected sizes (into the core) having energy gap values less than the energy of the photons of wavelength λ₀ results in production of light of wavelength λ₁ in addition to wavelength λ₀. Thus, embedding nanoparticles into a fiber optic provides a method of generating multiple wavelengths in addition to the source wavelength, which may be used in applications other than fiber optic diffusers.

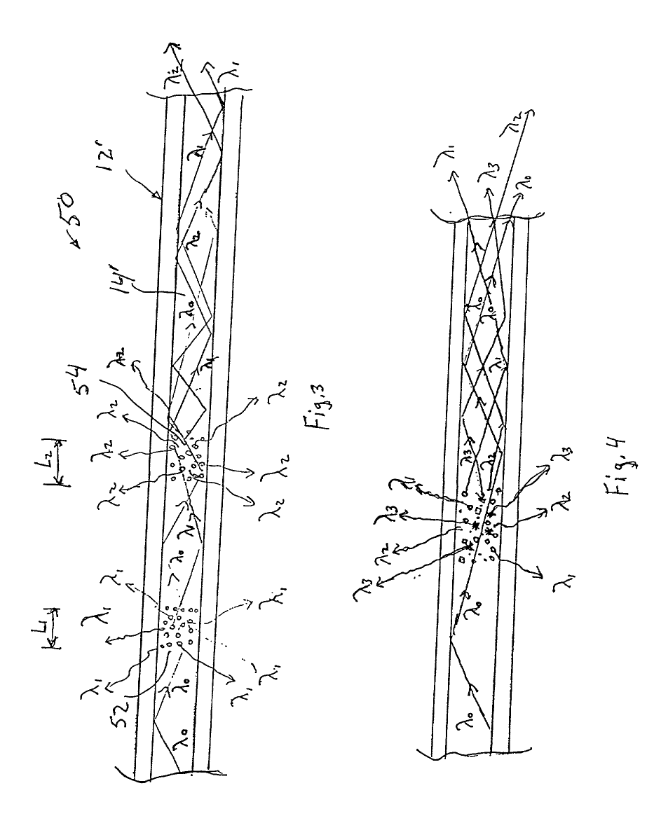

Referring to FIG. 3, another embodiment of a diffuser is shown at 50 in which multiple diffuser sections 52, 54 of length L₁ and L₂ respectively may be produced along the core 14′ of fiber optic 12′. Diffuser section 52 may include nanocrystals having energy gaps greater than the nanocrystals in diffuser section 54. In this way, some of the photons of wavelength λ₀ in the original light beam and photons of wavelength λ₁ emitted by nanoparticles in diffuser section 52 will be absorbed by the nanocrystals in diffuser section 54 which in turn emit photons of wavelength λ₂. The diffuser sections may comprise monodisperse nanocrystals for producing essentially a single wavelength output or may comprise a multitude of particle sizes as shown in FIG. 4 thereby emitting a large number of wavelengths. These different embodiments may also be implemented with the fiber optic diffuser tip 22 in FIG. 1, showing that either monodisperse nanocrystals or a mixture of different sizes may be used to provide emission with more than one wavelength.

It will be understood that the optical fiber diffusers disclosed herein have applicability to numerous other technologies outside of fiber optic communication or biomedical applications, for example any application requiring light emitted along a desired length of a fiber optic.

Incorporating nanocrystals into optical fibers may be used to produce useful devices other than optical diffusers. For example, the inclusion of nanoparticles of varying sizes into the optical fiber may be used to produce multiwavelength light sources within the fiber core itself as shown in FIGS. 2, 3 and 4 which are activated by the excitation source light beam. FIG. 5 shows a fiber optic light detector 60 comprising a fiber 62 with a fiber core 64 and cladding 66 with nanocrystals 68 incorporated into the core 64 which luminesce when light exterior to the fiber is incident on the nanocrystals and some of the luminescent light will be detected by the detector D. The process of coupling a light signal back into the fiber is not highly efficient but nevertheless some of the light incident on the diffuser will be captured and be absorbed by the nanoparticles with some of the emitted luminescent light being guided along the fiber core to be detected by detector D.

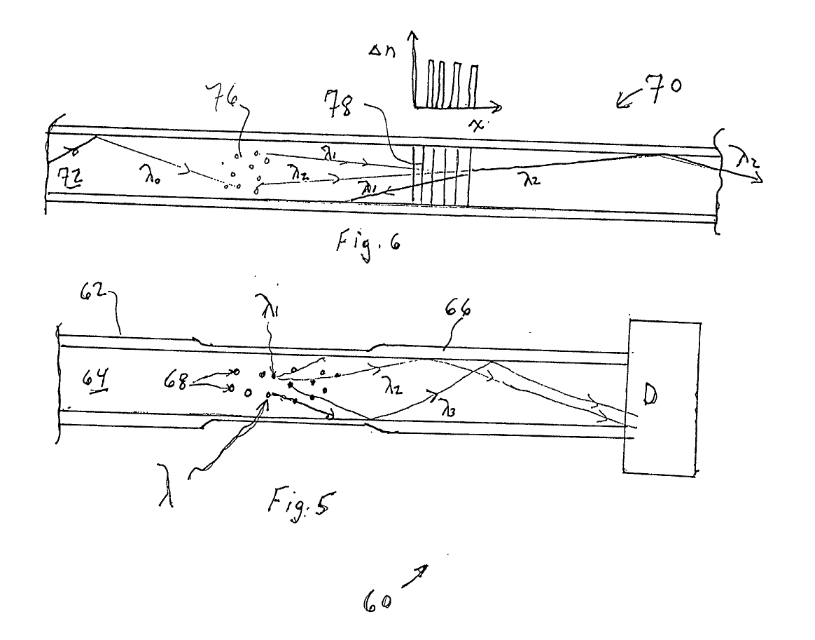

Referring to FIG. 6, a fiber optic 70 with nanoparticles 76 incorporated within the core 72 includes a fiber grating 78 written therein to give wavelength selectivity. The grating may be tuned using a tuning circuit which includes a mechanical stretcher, for example a piezo-electric transducer contacting the portion of the fiber containing the grating.

The foregoing description of the preferred embodiments of the invention has been presented to illustrate the principles of the invention and not to limit the invention to the particular embodiment illustrated. It is intended that the scope of the invention be defined by all of the embodiments encompassed within the following claims and their equivalents.

Therefore what is claimed is:

1. An optical fiber device with a multiwavelength output, comprising:
a multimode optical fiber having a fiber core, a cladding and a buffer enveloping said cladding, semiconductor nanoparticles of preselected size embedded in one or both of said core and cladding along a preselected length thereof, said semiconductor nanoparticles emitting electromagnetic radiation of pre-selected wavelengths by fluorescence responsive to being irradiated by electromagnetic radiation.

2. The optical fiber device according to claim 1 wherein said semiconductor nanocrystals have a mean size selected so that said fluorescence has a wavelength in a pre-selected wavelength range.

3. The optical fiber device according to claim 2 wherein the wavelength of said fluorescence is tunable by selecting a mean size, or size distribution, of the semiconductor nanocrystals incorporated into said fiber core or cladding.

4. The optical fiber device according to claim 3 wherein the semiconductor nanoparticles have a pre-selected density distribution along said pre-selected length of said core for emitting optical radiation with a pre-selected intensity distribution as a function of distance along said pre-selected length.

5. The optical fiber device according to claim 4 wherein said electromagnetic radiation is light propagating along said fiber core from a light source optically coupled to said optical fiber, and wherein said buffer is removed and the cladding thinned or removed along said pre-selected length so that some of the light emitted by the nanoparticles along said pre-selected length is emitted radially from said fiber core.

6. The optical fiber device according to claim 3 wherein said optical fiber is produced from a polymer.

7. The optical fiber device according to claim 3 wherein said optical fiber is a glass optical fiber.

8. The optical fiber device according to claim 4 wherein said optical fiber device is a light detector, wherein said buffer is removed and the cladding thinned along said pre-selected length, and wherein said electromagnetic radiation is light incident on said pre-selected length, and wherein some of the fluorescence emitted by said semiconductor nanocrystals propagates along said fiber core to a light detection means optically connected to said optical fiber.

9. The optical fiber device according to claim 8 wherein said semiconductor nanocrystals are embedded in said cladding.

10. The optical fiber device according to claim 4 including a fiber grating written therein, and tuning means for tuning said fiber grating for selecting specific wavelengths to be transmitted by said grating.

11. An optical fiber diffuser, comprising:
a multimode optical fiber having a fiber core, a cladding and a buffer enveloping said cladding, semiconductor nanoparticles of pre-selected size embedded in said core along a pre-selected length thereof, said buffer being removed along said pre-selected length, said nanoparticles emitting electromagnetic radiation of pre-selected wavelength responsive to being irradiated by electromagnetic radiation propagating along said fiber core from a light source optically coupled to said optical fiber.

12. The optical fiber device according to claim 11 wherein said semiconductor nanocrystals have a mean size selected so that said fluorescence has a wavelength in a pre-selected wavelength range.

13. The optical fiber device according to claim 12 wherein the wavelength of said fluorescence is tunable by selecting a mean size, or size distribution, of the semiconductor nanocrystals incorporated into said fiber core or cladding.

14. The optical fiber device according to claim 13 wherein the semiconductor nanoparticles have a pre-selected density distribution along said pre-selected length of said core for emitting optical radiation with a pre-selected intensity distribution as a function of distance along said pre-selected length.

15. The optical fiber device according to claim 11 wherein said cladding is thinned or removed along said pre-selected length.

16. A diffuser tip comprising a cylindrical central core of a substantially transparent elastomer, said cylindrical central core including a proximal end which abuts against the tip of an optical fiber or array of fibers and a distal end, said cylindrical central core containing semiconductor nanoparticles of preselected size embedded therein.

17. The diffuser tip according to claim 16 wherein said semiconductor nanoparticles are distributed within the cylindrical central core so that the concentration of semiconductor nanoparticles increases continuously in a direction from the proximal end of the diffuser tip to the distal end of the diffuser tip.

18. The diffuser tip according to claim 16 wherein the diameter of the cylindrical central core is equal to or greater than the outer diameter of the optical fiber.

19. The diffuser tip according to claim 16 wherein said semiconductor nanocrystals have a mean size selected so that said fluorescence has a wavelength in a pre-selected wavelength range.

20. The diffuser tip according to claim 19 wherein the wavelength of said fluorescence is tunable by selecting a mean size, or size distribution, of the semiconductor nanocrystals incorporated into said fiber core or cladding.
